(19) United States
(12) Patent Application Publication
(10) Pub. No.: US 2008/0234004 A1
(43) Pub. Date: Sep. 25, 2008

(54) Accessing A Multimedia Service From A Mobile Terminal

(75) Inventors: Nicolas Loque, Ifs (FR); Tiphaine Marie, St Gernaim La Blamche Herbe (FR); Jeremy Blanc, Boulougne-Billancourt (FR)

Correspondence Address: LOWE HAUPTMAN HAM & BERNER, LLP, 1700 DIAGONAL ROAD, SUITE 300, ALEXANDRIA, VA, 22314, US

(73) Assignee: France Telecom, Paris (FR)

(21) Appl. No.: 11/915,753

(22) PCT Filed: May 24, 2006
(86) PCT No.: PCT/FR2006/050475

§ 371 Date: Nov. 28, 2007

(30) Foreign Application Priority Data
Jun. 6, 2005 (FR) 0551509

(51) Int. Cl. H04M 5/06

(52) U.S. Cl. 455/564

(57) ABSTRACT

To access to a multimedia service designated by a call number in a mobile terminal connected to a radio communication network, a server predefines a correspondence table comprising call numbers associated with respective service identifiers and transmit it to the mobile terminal which stores it. When a call number is entered and confirmed by a channel seizing key in the terminal, an application determines the service identifier associated with the call number in the table and requests the setting up of a call with a server providing a multimedia service as a function of the determined service identifier. The call number can be transmitted to the server in order for the server to transmit a confirmation message comprising the call number or an address associated with the call number in order for the application to request the setting up of a call.

The present invention relates to accessing a multimedia service from a mobile terminal connected to a cellular radio communication network.

At present, on-line multimedia services, provided by an operator managing a cellular radio communication network, are accessible from mobile terminals integrating a graphical interface and managing menus and submenus for access to the services. Each mobile terminal manufacturer has its own implementation of said menus. Moreover, these menus are not always ergonomic and intuitive for most users having a mobile terminal whose use is often limited to entering a number to set up a call.

There is therefore a need for a mode of access to a multimedia service based on entering a number and adapted to the habits of users.

An object of the invention is accessing a multimedia service automatically from a mobile terminal by entering a call number on the mobile terminal, in order to remedy the above drawbacks.

To achieve this object, a method for access to a multimedia service designated by a call number in a mobile terminal connected to a radio communication network is characterized in that it includes in the mobile terminal the steps of:

determining, after confirmation of the call number, a service identifier associated with the call number in a correspondence table comprising call numbers associated with respective service identifiers, and

requesting the setting up of a call with a server providing a multimedia service as a function of the determined service identifier.

The user of the mobile terminal accesses a multimedia service simply by entering a call number associated with said multimedia service, the user being no longer constrained to use menus and submenus to access the service. The user therefore requires no particular knowledge of the sometimes complex functions of the mobile terminal and accesses the multimedia service quickly in the same way as a standard call.

Moreover, the unique association of the call numbers with respective multimedia services in the correspondence table confers a universal character on the use of the latter in accordance with the invention in the various types of mobile terminal each of which has its own implementations.

The invention also concerns a terminal for access to a multimedia service designated by a call number in a mobile terminal connected to a radio communication network, which is characterized in that it includes:

means for determining, after confirmation of the call number, a service identifier associated with the call number in a correspondence table comprising call numbers associated with respective service identifiers, and

means for requesting the setting up of a call with a server providing a multimedia service as a function of the determined service identifier.

The invention also relates to two embodiments of a server authorizing access to a multimedia service designated by a call number in a mobile terminal connected to a radio communication network.

According to a first embodiment, the call number is transmitted to the network and analyzed by the server which in response transmits it back to the mobile terminal. The server then includes a table of correspondences between call numbers and user identifiers, and transmits a confirmation message comprising the call number to the mobile terminal if it finds a correspondence between the call number transmitted by the mobile terminal and a user identifier transmitted by register means of the network in the table of correspondence, in order for the mobile terminal to extract the call number from the confirmation message received by the mobile terminal to determine the service identifier associated with the call number.

According to a second embodiment, the call number is transmitted to the network and analyzed by the server which in response transmits a URL address associated with the call number to the mobile terminal. The server then includes a table of correspondences between call numbers and user identifiers, and transmits the address associated with the call number to the mobile terminal if it finds a correspondence between the call number transmitted by the mobile terminal and a user identifier transmitted by register means of the network in a correspondence table, in order for the mobile terminal to request the setting up of a call with a server providing a multimedia service designated by the address.

The invention also relates to a computer program adapted to be executed in a terminal to access a multimedia service designated by a call number in a mobile terminal connected to a radio communication network, said program comprising instructions which, if the program is loaded into and executed in said terminal, execute in accordance with the method of the invention the steps of:

determining, after confirmation of the call number, a service identifier associated with the call number in a correspondence table comprising call numbers associated with respective service identifiers, and

requesting the setting up of a call with a server providing a multimedia service as a function of the determined service identifier.

Finally, the invention concerns a method for making available a computer program with a view to downloading it from a first server into a mobile terminal to access a multimedia service designated by a call number in the mobile terminal connected to a radio communication network, said program comprising instructions which, if the program is loaded into and executed in said terminal, executes the steps according to the method of the invention.

According to another feature of making the computer program available, the first server authorizes access to the multimedia service designated by the call number in the mobile terminal if the first server finds a correspondence between the call number transmitted by the mobile terminal and a user identifier.

Other features and advantages of the present invention will become more clearly apparent on reading the following description of preferred embodiments of the invention, provided by way of nonlimiting example, with reference to the corresponding appended drawings, in which:

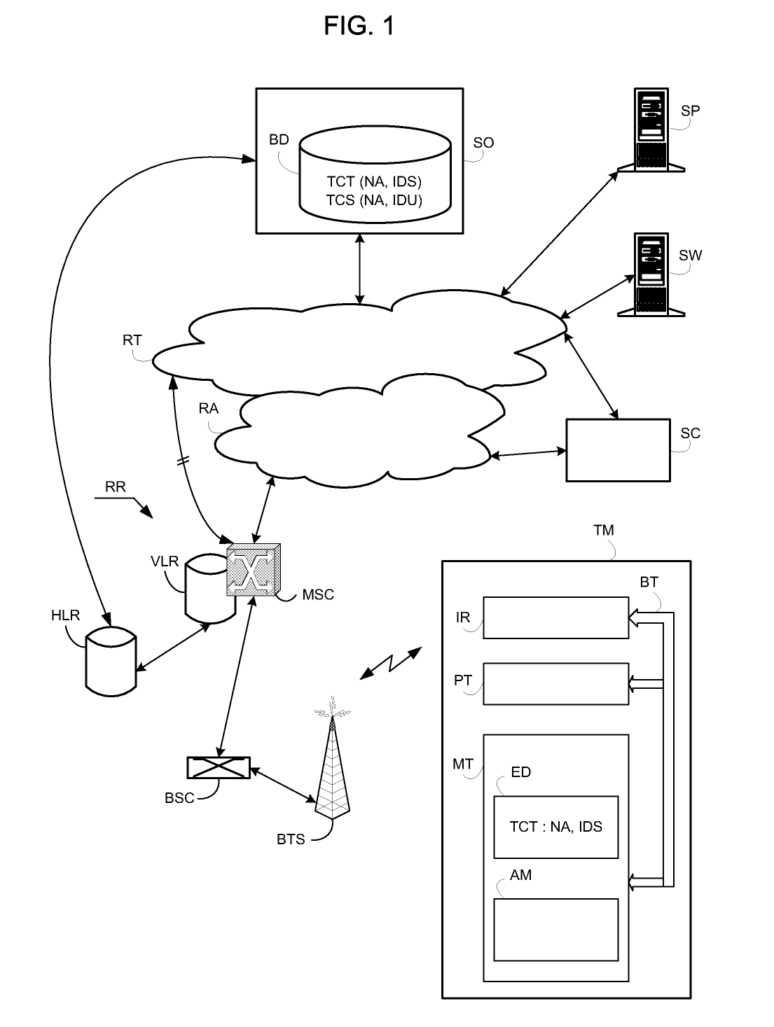

FIG. 1 is a schematic block diagram of a telecommunication system for access to a multimedia service from a mobile terminal in accordance with the invention;

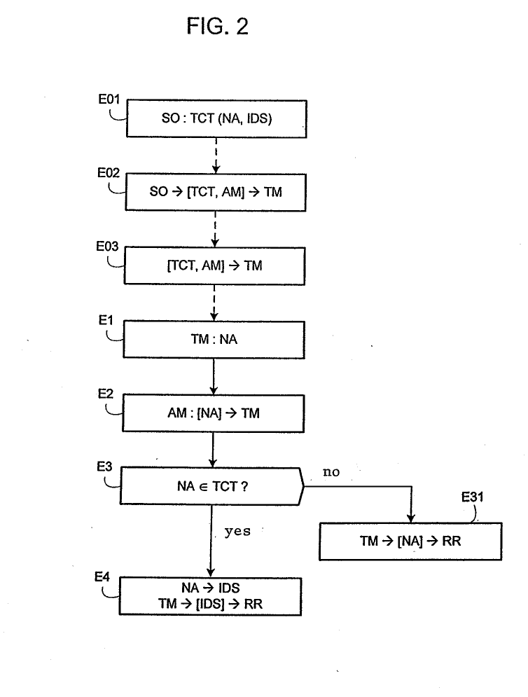

FIG. 2 is an algorithm of a method for access to a multimedia service from a mobile terminal in accordance with a first embodiment of the invention;

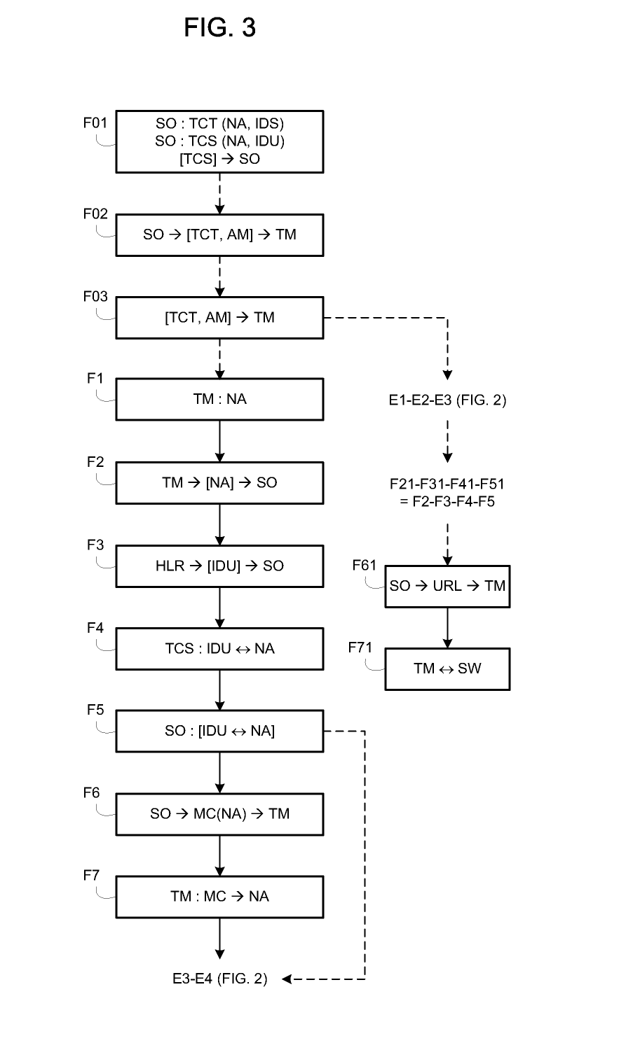

FIG. 3 is an algorithm of a method for access to a multimedia service from a mobile terminal in accordance with a second embodiment of the invention.

Referring to FIG. 1, a mobile terminal TM is supplied to a user by an operator that manages a digital cellular radio communication network RR. The radio communication network RR is of GSM type, for example. In FIG. 1 there are represented only the principal elements of the location area of the network RR in which the mobile terminal TM is located at a given time. The location area comprises a mobile service switching center MSC that is connected via a base station controller BSC to a base station BTS connected by a radio link to the mobile terminal TM.

As is known in the art, the network RR also comprises a home location register HLR connected to a plurality of visitor location registers VLR, including that connected to the switching center MSC of the location area concerned. The register HLR is analogous to a database containing for each user an IMSI (International Mobile Subscriber Identity) international identity attached to the user, the user's subscription profile, and the number of the register VLR to which the mobile terminal TM is temporarily attached. The register VLR serves to relay the register HLR in the location area and contains characteristics of users whose mobile terminals are situated in the location area.

An operator server SO, providing an OTA (Over The Air) service platform, is managed by the operator of the network RR.

According to the embodiment shown in FIG. 1, the operator server SO transmits data messages to the mobile terminal TM via a short message server (Short Message Service Center) SC. The server SC includes an access gateway for communicating with the operator server SO via a high bit rate telecommunication network RT, in particular the Internet, or alternatively an Intranet network, and another access gateway for communicating with at least the mobile service switching center MSC previously referred to, via an access network RA such as an X.25 type packet network or an ISDN or ATM network. The packets transmitted by the server SO are formatted in the server SC as SMS (Short Message Service) short messages and/or MMS (Multimedia Messaging Service) multimedia messages transmitted to the mobile terminal TM.

According to a first variant, the server SC is connected directly to or is incorporated in the switching center MSC and the operator server SO is connected directly to or is incorporated in the home location register HLR, which enables the server SO to benefit directly from data stored in the register HLR.

According to a second variant, the short message server SC and the access network RA are replaced by an access network of the GPRS (General Packet Radio Service) packet-switched network type with mobility management and radio access. The telecommunication network RT is then connected to a GGSN (Gateway GPRS Support Node) gateway node to the GPRS network, and the base station controller BSC is connected via an SGSN (Serving GPRS Support Node) serving node. The benefit of this variant is transmitting messages in the form of packets with much higher bit rates.

According to a third variant, the cellular radio communication network RR is of the third generation, i.e. a UMTS network. In this case, the controller BSC and the base station BTS are combined in the UTRAN (UMTS Terrestrial Radio Access Network) access network of the UMTS network.

Conventionally, a database BD is connected to the operator server SO, i.e. it is either integrated into the operator server SO or incorporated into a database management server and connected to the operator server by a local or remote link. The database BD includes in particular information necessary for implementing the invention such as a correspondence table TCT comprising call numbers NA and service indicators IDS and a correspondence table TCS comprising call numbers NA and user identifiers IDU.

A partner server SP connected to the network RR can contain the correspondence table TCT in a memory.

Alternatively, the partner server SP and the operator server SO are combined in or integrated into a single server that communicates with or includes the database BD.

The mobile terminal TM conventionally comprises a radio interface IR, a processor PT, and memories MT. The various elements of the terminal are interconnected by a bidirectional bus BT. The memories MT combine various memories such as a read-only memory ROM, a non-volatile memory EEPROM, and RAM. The radio interface IR transposes in frequency, converts digitally, demodulates and decodes messages received via the network RR, and conversely sends messages.

The memories MT in the terminal TM include in particular an operating system, an execution environment such as a Java virtual machine, for example, and a data space ED for storing data such as a correspondence table TCT comprising call numbers NA and service indicators IDS.

In the nonvolatile memory of the memories MT are implemented mobile applications, initially written in a high-level language of the object-oriented type such as the language Java compatible with the virtual machine. In particular, a mobile application AM specific to the invention analyzes the correspondence table TCT in order to control access to multimedia services, such as Internet access.

Alternatively, the mobile application AM and the data space ED are implemented in a memory of a microchip card, also referred to as a microcontroller card or an integrated circuit card, constituting a user identity module of the UICC (Universal Integrated Circuit Card) type removable from the mobile terminal and connected to the mobile terminal by electrical contacts or without electrical contact. The microchip card is a SIM card for a cellular radio communication network of the GSM or GPRS type, for example, or a USIM (Universal Subscriber Identity Module) identity module for a UMTS type CDMA Code Division Multiple Access network of third generation (3GPP).

In the remainder of the description, the expression mobile terminal TM refers to the terminal with the microchip card of the removable user identity module type.

The mobile terminal TM is preferably a mobile cellular radio communication terminal. Alternatively, the mobile terminal TM is a communicating personal digital assistant (PDA) or a SmartPhone able to communicate with the network RR and to exchange commands and responses with a microchip card.

According to another variant, the mobile terminal TM comprises a touch-screen and functions necessary for interpreting actions on the touch-screen.

According to a further variant, the mobile terminal TM comprises miniature accelerometers adapted to detect and interpret movements of the mobile terminal in space at the initiative of the user, such as a movement simulating picking up a telephone handset to command the seizing of a channel in the mobile terminal.

According to a further variant, the mobile terminal TM comprises a voice recognition engine adapted to interpret voice commands spoken by the user.

According to the invention, the digital cellular radio communication network RR offers multimedia services accessible from the mobile terminal TM connected to the network RR. A multimedia service is a service providing multimedia documents. A multimedia document is a digital file comprising text and/or sound and/or at least one image and/or at least one video sequence. To access an on-line multimedia service, the mobile terminal contains a browser that exchanges data conforming to the WML (Wireless Markup Language) or XHTML (extensible Hypertext Markup Language) format, for example, with a web site server SW connected to the telecommunication network RT in accordance with the WAP (Wireless Application Protocol) communication protocol. The user can consult film showing times, for example, or weather forecasts on web sites by means of the mobile terminal. In order not to overcomplicate FIG. 1, only one web site server SW managing at least one web site is shown.

According to a first embodiment shown in FIG. 2, the method according to the invention of access to a multimedia service comprises steps E1 to E4 executed automatically in the mobile terminal TM and preceded by preliminary steps E01 to E03.

In the step E01, the operator server SO predefines a correspondence table TCT comprising call numbers NA associated with respective service identifiers IDS. For example, one call number NA is 6-3-8 corresponding to the keys N-E-T of the keypad of the mobile terminal TM, this number being short and easily linked to the “Internet” service for the user. In another example, the call number NA is 6-3-8-3-6 corresponding to the keys M-E-T-E-O of the keypad of the terminal, this number being associated with a service identifier IDS that relates to an IP address for consulting weather forecasts.

In the step E02, the correspondence table TCT and the mobile application AM necessary for the interpretation of the correspondence table TCT are downloaded from the operator server SO into the mobile terminal TM. The step E02 is executed at the initiative of the user, who wishes to subscribe to a service using the method of the invention. For example, the user of the mobile terminal TM calls a call center of the operator in order to choose a list of services corresponding to respective service identifiers IDS from the correspondence table TCT and the operator server SO downloads into the mobile terminal of the user an installation kit including in particular the application AM, the correspondence table TCT, and an installation program.

In the step E03, the received correspondence table TCT is stored in the data space ED of the mobile terminal TM and the mobile application AM is stored in the nonvolatile memory of the memories MT of the mobile terminal or in a memory of the microchip card connected to the mobile terminal. The application AM and the correspondence table TCT are preferably stored automatically, for example by means of the installation program supplied by the operator server.

Alternatively, if the mobile application AM and the correspondence table TCT are already stored in the mobile terminal TM, if the user wishes to access other services by means of other call numbers, the operator server transmits the mobile terminal of the user an update message comprising only a new correspondence table that is stored in the mobile terminal and combined with the correspondence table TCT already stored.

In another variant, the mobile application AM and the correspondence table TCT are stored in the mobile terminal TM before the latter is sold, for example during implementation of the mobile terminal by its manufacturer.

In another variant, the correspondence table TCT is stored in a memory of an electronic device external to the mobile terminal TM and accessible by the mobile application AM. For example, the electronic device is a communicating personal digital assistant (PDA), a SmartPhone, a personal computer, or a USB key, communicating with the mobile terminal via a respective appropriate link.

In another variant, the correspondence table TCT is stored in a memory of the partner server SP whose address has been previously entered or downloaded into the mobile terminal or stored in the mobile terminal before it is sold. The mobile application accesses the correspondence table TCT by interpreting said partner server address.

The mobile terminal is then configured to access multimedia services via predefined call numbers chosen by the user as described hereinabove.

In the step E1, the user wishing to access a multimedia service designated by a call number NA enters the call number NA on the keypad of the mobile terminal TM. Alternatively, the call number NA is prestored in a directory of the mobile terminal and associated with a directory entry. For example, the entry “METEO” is associated with the number “63836”. The user then selects an entry from the directory. The user then confirms the call number NA in the usual way, by pressing a special key on the mobile terminal for seizing a channel, but without the terminal sending the call number NA to the network RR.

In one variant, the call number NA is entered and then confirmed through interpretation of specific movements of the mobile terminal TM in space by means of miniature accelerometers of the mobile terminal. For example, the number is confirmed by a signal that comes from the accelerometers and is linked to a channel seizing movement.

In another variant, the call number NA is entered and then confirmed on the touch-screen of the mobile terminal TM.

In another variant, the call number NA is entered and then confirmed as a function of voice commands spoken by the user of the mobile terminal, the commands being detected and interpreted by the voice recognition engine of the mobile terminal.

In the step E2, the mobile application AM detects, intercepts, and stores the call number entered or selected automatically before the call number NA is sent to the network RR.

In the step E3, the mobile application AM determines the service identifier IDS associated with the call number NA in the correspondence table TCT. The intercepted call number NA is compared to the call numbers included in the correspondence table TCT.

If the intercepted call number NA is included in the correspondence table TCT, the mobile application AM reads the service identifier IDS relating to the call number. For example, the service identifier IDS contains the URL (Uniform Resource Locator) address of an Internet site.

If the correspondence table TCT is stored in an external memory accessible by the mobile terminal TM, such as the memory of the partner server SP or of an electronic device, the determination step E3 includes setting up a call between the mobile application AM and a dedicated application managing said memory in order to transmit the service identifier IDS that has been read to the mobile terminal TM.

In the step E4, the mobile application AM then requests the setting up of a call with a web server SW providing a multimedia service as a function of the service identifier IDS that has been read. For example, the application AM interprets a URL address corresponding to the service identifier that has been read and commands the browser of the mobile terminal to connect to the server SW designated by the URL address.

Reverting to the step E3, if the intercepted call number NA is not included in the correspondence table TCT and is a MSISDN Mobile Subscriber ISDN Number, for example, the mobile application AM authorizes in a step E31 and in a standard manner the setting up of a call with a terminal designated by the call number NA, the latter being sent to the network RR.

According to a second embodiment shown in FIG. 3, the call number NA entered is sent to the network RR, analyzed by an operator server SO and forwarded to the mobile terminal TM, in steps F1 to F7 completing the process of access to a multimedia service in accordance with the invention.

The steps E01 to E03 are replaced by steps F01 to F03, respectively, and the steps E1 and E2 are replaced by steps F1 to F7.

The step F01 differs from the step E01 in that the operator server SO also predefines a correspondence table TCS comprising call numbers NA each associated with respective user identifiers IDU as a function of user subscription profiles. The identifier IDU of a user indicates to the server SO if the user has a subscription authorizing access to the service associated with the call number NA received. The identifier IDU of a user can be a portion of the user's IMSI. The correspondence table TCS is sent beforehand by the register HLR to the operator server SO, which stores it in the database BD.

The steps F02 and F03 are identical to the steps E02 and E03, the correspondence table TCT and the mobile application AM being transmitted from the operator server SO to the mobile terminal TM and stored in the latter.

The step F1 is identical to the step E1, a call number NA having been entered and confirmed on the mobile terminal TM.

In the step F2, the call number NA is transmitted from the mobile terminal TM to the operator server SO via the radio communication network RR. The call number NA is considered different from an MSISDN Mobile Subscriber ISDN Number by the mobile service switching center MSC that transmits it in short message form to the operator server SO via the short message server SC. The mobile application AM switches into a standby state and listens for reception of a short message from the network RR.

In the step F3, the operator server SO receives the call number NA sent by the terminal TM via the register VLR that signals transmitting of the short message to the register HLR in order for the latter to transmit the user identifier IDU to the operator server SO.

In the step F4, the operator server SO looks for the call number NA transmitted by the terminal TM in corresponding relationship with the user identifier IDU transmitted by the register HLR in the correspondence table TCS.

If the server SO finds the correspondence between the call number NA transmitted and the user number IDU transmitted in the table TCS, it proceeds to the optional step F5 and to the step F6.

In the step F5, the operator server SO stores the user identifier IDU transmitted by the mobile terminal TM in association with the call number NA and the time of day of reception of the latter in the database BD in order to obtain a history of service requests coming from the user of the mobile terminal and to bill the calls relating to the services requested.

Then, in the step F6, the operator server SO sends a confirmation message MC comprising in particular the received call number NA to the mobile terminal TM. In the embodiment shown in FIG. 1, the confirmation message MC is sent via the telecommunication network RT in packet form and is converted by the short message server SC into a short message sent to the mobile terminal TM.

In the step F7, following reception of the confirmation message MC in the mobile terminal TM, the mobile application AM intercepts and interprets the confirmation message MC in order to extract from it the call number NA.

The process then continues with the steps E3 and E4 for determining the service identifier IDS associated with the call number NA in the correspondence table TCT and requesting the setting up of a call with a server providing a multimedia service designated by the service identifier IDS that has been read.

Reverting to the step F4, if the correspondence between the call number NA transmitted and the user identifier IDU transmitted is absent in the table TCS, the server SO forwards the received call number NA to the network RR, the call number being an MSISDN mobile Subscriber number, for example, or transmits an error message to the mobile terminal TM indicating that the call number NA does not correspond to an available service.

In a first variant, the steps F6 and F7 are not executed and the operator server SO does not transmit a message to the mobile terminal TM. Because the mobile application AM has stored the call number NA beforehand, in the step F2, before it is transmitted to the operator server SO, it executes the steps E3 and E4, as indicated in dashed line in FIG. 3.

In a second variant, the steps E1, E2 and E3 are executed in the mobile terminal TM after the initial steps F01 to F03, as indicated in dashed line in FIG. 3. Then the steps F21, F31, F41 and F51 similar to the steps F2, F3, F4 and F5, respectively, are executed after the step E3 and before the step E4 of requesting the setting up of a call with a server SW, the mobile application AM not having determined any service identifier IDS associated with the call number NA in the correspondence table TCT. In this case, the mobile terminal TM transmits the confirmed call number NA to the operator server SO in the step F21. The server SO receives the user identifier IDU transmitted by the register HLR in the step F31. The server SO then looks for a correspondence between the call number NA and the user identifier IDU in the correspondence table TCS in the step F41 in order to proceed where applicable to the step F51 and to continue with a step F61 if the server SO finds said correspondence.

In the step F61, the operator server SO transmits a URL address associated with the call number NA to the mobile terminal TM. Then, in a step F71, the mobile application AM interprets the received URL address and requests the browser of the mobile terminal TM to set up a call with a server SW providing a multimedia service designated by the URL address.

The invention described here relates to a method and a mobile terminal for access to a multimedia service designated by a call number NA in the mobile terminal connected to a radio communication network. In a preferred embodiment, the steps of the method of the invention are determined by the instructions of a computer program incorporated in the mobile terminal or an information medium. The program includes program instructions which, if said program is loaded into and executed in the mobile terminal, the operation whereof is then controlled by the execution of the program, execute the steps of the method according to the invention.

Consequently, the invention applies also to a computer program, in particular a computer program or in an information medium, adapted to implement the invention. That program can use any programming language and be in the form of source code, object code, or an intermediate code between source code and object code, such as in a partially compiled form, or in any other form desirable for implementing the method according to the invention.

The information medium can be any entity or device capable of storing the program. For example, the medium can include storage means or a storage medium, such as a ROM, for example a CD ROM or a microelectronic circuit ROM, or a USB key, or magnetic storage means, for example a diskette (floppy disk) or a hard disk.

Moreover, the information medium can be a transmissible medium such as an electrical or optical signal, which can be routed via an electrical or optical cable, by radio or by other means. The program according to the invention can in particular be downloaded over an Internet type network.

Alternatively, the information medium can be an integrated circuit into which the program is incorporated, the circuit being adapted to execute the method according to the invention or to be used in its execution.

1. A method of accessing to a multimedia service designated by a call number in a mobile terminal connected to a radio communication network, said method including in the mobile terminal:
determining, after confirmation of the call number, a service identifier associated with the call number in a correspondence table comprising call numbers associated with respective service identifiers, and
requesting the setting up of a call with a server providing a multimedia service as a function of the determined service identifier.

2. A method as claimed in claim 1, further including, before the step of determining and after the confirmation, the steps of:
transmitting the call number from the mobile terminal to the server means,
transmitting a confirmation message including the call number from the server means to the mobile terminal if the server means finds a correspondence between the call number transmitted by the mobile terminal and a user identifier transmitted by register means of the network in a correspondence table, and
extracting the call number from the confirmation message received by the mobile terminal to determine the service identifier associated with the call number.

3. A method as claimed in claim 1, further including before the step of requesting, if any service identifier associated with the call number is not determined in the correspondence table, the steps of:
transmitting the call number from the mobile terminal to the server means,
transmitting an address associated with the call number from the server means to the mobile terminal if the server means finds a correspondence between the call number transmitted by the mobile terminal and a user identifier transmitted by register means of the network in a correspondence table, so as to request the setting up of a call with a server providing a multimedia service designated by the address.

4. A method as claimed in claim 1, wherein the correspondence table is predefined in the server means and downloaded from the server means into the mobile terminal.

5. A method as claimed in claim 1, further including, before the confirmation, a step of storing the correspondence table in the mobile terminal.

6. A method as claimed in claim 1, further including, before the confirmation, a step of storing the correspondence table in a memory external to the mobile terminal.

7. A method as claimed in claim 1, wherein the call number is confirmed by a channel seizing key in the mobile terminal.

8. A mobile terminal for access to a multimedia service designated by a call number in a mobile terminal connected to a radio communication network, characterized in that it includes:
means for determining, after confirmation of the call number, a service identifier associated with the call number in a correspondence table comprising call numbers associated with respective service identifiers, and
means for requesting the setting up of a call with a server providing a multimedia service as a function of the determined service identifier.

9. A server for authorizing access to a multimedia service designated by a call number in a mobile terminal connected to a radio communication network,
characterized in that it includes a table of correspondences between call numbers and user identifiers, and
in that it transmits a confirmation message comprising the call number to the mobile terminal if it finds a correspondence between the call number transmitted by the mobile terminal and a user identifier transmitted by register means of the network in the table of correspondence,
in order for the mobile terminal to extract the call number from the confirmation message received by the mobile terminal to determine the service identifier associated with the call number.

10. A server for authorizing access to a multimedia service designated by a call number in a mobile terminal connected to a radio communication network,
characterized in that it includes a table of correspondences between call numbers and user identifiers, and
in that it transmits the address associated with the call number to the mobile terminal if it finds a correspondence between the call number transmitted by the mobile terminal and a user identifier transmitted by register means of the network in a correspondence table,
in order for the mobile terminal to request the setting up of a call with a server providing a multimedia service designated by the address.

11. A computer arrangement adapted to be performed in a mobile terminal to access a multimedia service designated by a call number in a mobile terminal connected to a radio communication network, said computer arrangement comprising instructions adapted to execute the steps of:
determining, after confirmation of the call number, a service identifier associated with the call number in a correspondence table comprising call numbers associated with respective service identifiers, and
requesting the setting up of a call with a server providing a multimedia service as a function of the determined service identifier.

12. A method of making available a computer program with a view to downloading it from a first server into a mobile terminal to access a multimedia service designated by a call number in a mobile terminal connected to a radio communication network, said program comprising instructions which, if the program is loaded into and executed in said terminal, executes the steps:
determining, after confirmation of the call number, a service identifier associated with the call number in a correspondence table comprising call numbers associated with respective service identifiers, and
requesting the setting up of a call with a server providing a multimedia service as a function of the determined service identifier.

13. A method as claimed in claim 13, wherein the first server authorizes access to the multimedia service designated by the call number in the mobile terminal if the first server finds a correspondence between the call number transmitted by the mobile terminal and a user identifier.
